(19) United States
(12) Patent Application Publication
(10) Pub. No.: US 2010/0034407 A1
(43) Pub. Date: Feb. 11, 2010

(54) ARRANGEMENT AND METHOD FOR REGULATION OF FEEDBACK SUPPRESSION IN HEARING DEVICES

(76) Inventors: Stefan Petrausch, Erlangen (DE); Wolfgang Sörgel, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/536,697

(22) Filed: Aug. 6, 2009

(30) Foreign Application Priority Data
Aug. 7, 2008 (DE) 10 2008 036 803.2

(51) Int. Cl. H04R 25/00

(52) U.S. Cl. 381/318

(57) ABSTRACT

The invention specifies a hearing device, especially an in-the-ear hearing aid, and a method for suppressing acoustic feedback, with at least one ultrasound signal being emitted by the hearing device. The ultrasound signal reflected and fed back from the environment of the hearing device is picked up by at least one microphone and/or by at least one ultrasound receive unit of the hearing device. A feedback suppression unit of the hearing device is regulated by the picked up and evaluated ultrasound signal. The advantage of this is that feedback suppression in hearing devices can be regulated both quickly and also precisely.

### CROSS REFERENCE TO RELATED APPLICATIONS

This application claims priority of German application No. 10 2008 036 803.2 filed Aug. 7, 2008, which is incorporated by reference herein in its entirety.

### FIELD OF THE INVENTION

The invention relates to a hearing device, for example a hearing aid, with a feedback suppression unit able to be regulated for suppressing acoustic feedback, and to a method for suppressing acoustic feedback in hearing devices.

### BACKGROUND OF THE INVENTION

If couplings occur in a signal processing system between the inputs and the outputs (e.g. acoustic, electromagnetic, electrical, magnetic etc.) feedback effects can arise. One example of such an arrangement is a hearing aid shown schematically in FIG. 1. The hearing aid can be depicted as digital system 1, which is to be found in an acoustic environment. A microphone 2 typically forms its input. Processing of the detected signal 9 includes amplification and is output again via an earpiece 3. The acoustic coupling from the earpiece 3 back to the microphone 2 is undertaken over a physical feedback path 4. The signal picked up thus consists of the sum of an incident useful signal 8 and the signal over the feedback path 4. As a result of the feedback, feedback whistling occurs when both the amplitude and also the phase condition is fulfilled. Sound artifacts even occur if the above conditions are only approximately fulfilled.

To suppress the feedback effects there is a known method in which the physical feedback path 4 is emulated digitally. The emulation is performed by means of an adaptive filter 5 which is fed by the earpiece signal. The earpiece signal in its turn originates from a signal processing unit 6 within the hearing aid which picks up the microphone signal and processes it using operations including amplification. After filtering in the adaptive compensation filter, the earpiece signal will be subtracted from the microphone signal in an adder 7.

Two paths thus exist in the system, one is the physically-existing feedback path 4 and one is the emulated digital compensation path emulated via the adaptive filter 5. Since the resulting signals of the two paths are subtracted from one another at the input to the device, in the ideal situation the effect of the physical feedback path 4 is canceled out.

An important component in the adaptive algorithm for compensating for the feedback path is its increment control. It specifies the speed at which the adaptive compensation filter 5 adapts to the physical feedback path 4. Since there is no sensible compromise for a fixed increment, this must be adapted to the current situation in which the system finds itself in each case. In principle the aim is to have a large increment for a rapid adaptation of the adaptive compensation filter to the physical feedback filter 4. The disadvantage of the large increment however is the generation of perceptible signal artifacts.

For far less than critical feedback the increment should be insignificantly small. If on the other hand a critical feedback situation arises, the increment should be large. It is thus guaranteed that the algorithm only adapts the adaptive compensation filter 5 if this differs significantly in its characteristics from the characteristics of the physical feedback path 4, i.e. when there is a need to adjust the adaptation. A feedback detector is needed for this purpose.

A method and a hearing device for feedback suppression are known from DE 10 2006 023 723 A1. In this invention the hearing device has an analysis device for analyzing the resonance behavior of the overall system as a function of a modification of a signal processing device and for determining from the result of the analysis a feedback variable representing a measure of the feedback. On the basis of the feedback variable the increment of an adaptive compensation filter is controlled to compensate for the feedback.

DE 10 2004 019353 B3 specifies a hearing aid with at least one proximity sensor which makes an operating function possible even without direct contact with an operating element. Conventional proximity sensors, such as infrared or ultrasound sensors, can be used as proximity sensors for example.

DE 10 2005 037895 B3 specifies a hearing device with a sound output device for issuing a test sound in the ultrasound range, so that audible sound does not have to be used for calibrating room acoustics.

DE 10 2004 050304 B3 specifies a hearing aid and a method for improving the reduction of feedback. To this end an output signal is modulated inaudibly with the aid of a modulation unit for a hearing aid wearer. The output signal can be modulated by amplitude or phase modulation as well as by modulation of the signal curve. The modulated output signal is fed back to the microphone of the hearing aid. A feedback detector detects the signal modulation and controls an adaptive filter accordingly.

### SUMMARY OF THE INVENTION

The object of the present invention is to specify a further facility and an associated method for feedback suppression.

In accordance with the invention the desired object is achieved with the hearing device and also with the method as claimed in the claims.

The invention claims a hearing device with at least one microphone and with a feedback suppression unit able to be regulated for suppressing acoustic feedback. The hearing device also comprises at least one ultrasound transmit unit emitting ultrasound signals, with the feedback suppression unit able to be regulated by the ultrasound signals picked up by the least one microphone. This has the advantage of enabling feedback to be regulated both quickly and also precisely.

The invention also claims a hearing device with a feedback suppression unit able to be regulated for suppressing acoustic feedback. The hearing device can also comprise at least one ultrasound transmit unit emitting ultrasound signals and at least one ultrasound receive unit picking up ultrasound signals, with the feedback suppression unit able to be regulated by the ultrasound signals picked up by the ultrasound receive unit. This has the advantage that the feedback can be regulated both quickly and also precisely and that the ultrasound signal is able to be received independently of a microphone of the hearing device

The hearing device can comprise a hearing aid, especially an in-the-ear hearing aid.

In a further development the hearing device can include a differentiation unit which detects changes in the ultrasound signal picked up for regulation of the feedback suppression unit.

In a further embodiment the feedback suppression unit can include regulation of the increment, with the increment able to be regulated by the ultrasound signal picked up.

Furthermore each change detected in the ultrasound signal picked up can regulate the feedback suppression unit such that the increment is changed during the change. By this method only changes in the fed back ultrasound signals are taken into account.

Preferably each change detected in the ultrasound signal picked up can regulate the feedback suppression unit such that the increment is changed during the change and in a predeterminable manner after the change. This offers the advantage of a high level of flexibility of regulation.

In a development the size of the change of the increment is able to be predetermined as a fixed value.

In a further embodiment the size of the change of the increment can be proportional to the change in the power of the ultrasound signal picked up.

Preferably the ultrasound signal emitted by the ultrasound transmit unit can be modulated. The advantage of this is that the received ultrasound signal can be securely and easily distinguished from interference signals and foreign ultrasound signals.

The invention also claims the method of suppressing acoustic feedback in hearing devices, with the following steps:
Output of at least one ultrasound signal by the hearing device,
Picking up of the ultrasound signal output by at least one microphone and/or at least one ultrasound receive unit of the hearing device and
Regulation of a feedback suppression unit of the hearing device by the ultrasound signal picked up.

In a further development the changes in the ultrasound signal picked up can be detected for the regulation of the feedback suppression unit.

In a further embodiment an increment of the feedback suppression unit can be regulated by the ultrasound signal picked up.

Preferably the increment can be changed during the change by each detected change of the ultrasound signal picked up.

Furthermore the increment can be changed during the change and in a predetermined manner thereafter by each detected change of the ultrasound signal picked up.

In a further development the increment can be changed using a fixed predetermined size.

In a further development the increment can be changed in proportion to the change in the output of the ultrasound signal picked up.

Preferably the ultrasound signal output can be modulated.

The invention also claims a computer program product with a computer program featuring software means that carry out the inventive method when the computer program is executed on a control unit of the hearing device.

### BRIEF DESCRIPTION OF THE DRAWINGS

Further special features and advantages of the invention are evident from the subsequent explanations of the number of exemplary embodiments which refer to schematic diagrams.

The figures show:

FIG. 1: a block diagram of feedback suppression according to the prior art,

FIG. 2: an inventive in-the-ear hearing aid and

FIG. 3: a block diagram of inventive regulation of hearing aid feedback suppression.

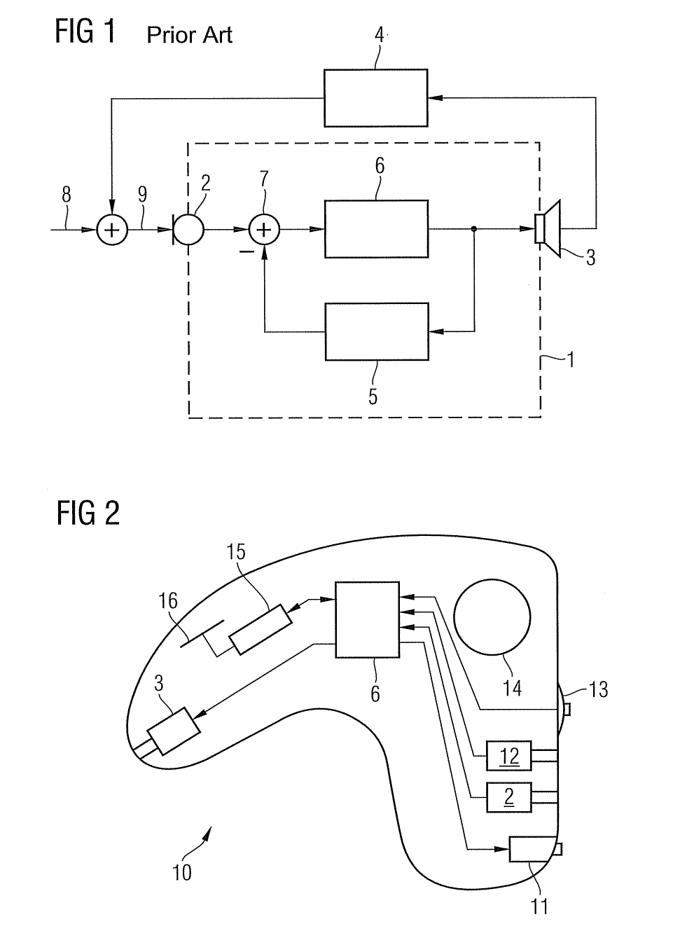

### DETAILED DESCRIPTION OF THE INVENTION

FIG. 2 shows a hearing aid 10 able to be worn in the ear with its major components. A microphone 2 with a sound entry opening for picking up an acoustic signal converts the signal picked up into an electrical signal. The electrical signal is fed for further processing and frequency-dependent amplification to a signal processing unit 6. Normally the further processed and amplified signal is converted back by means of an earpiece 3 from an electrical signal into an acoustic signal and issued via a sound canal into the auditory canal of the hearing aid wearer. A battery 14 is used to supply power to the electrical components of the hearing device 10.

The transmission characteristics of the hearing aid 10 described in the exemplary embodiment are able to be adapted to different hearing situations (e.g. “quiet environment”, “conversation”, “conversation in a noisy environment”, car journey” etc.). The selection is made by setting specific parameters sets (hearing programs) which adapt the signal processing 6 to the respective hearing situation. A pushbutton 13 is pressed to switch between the individual hearing programs.

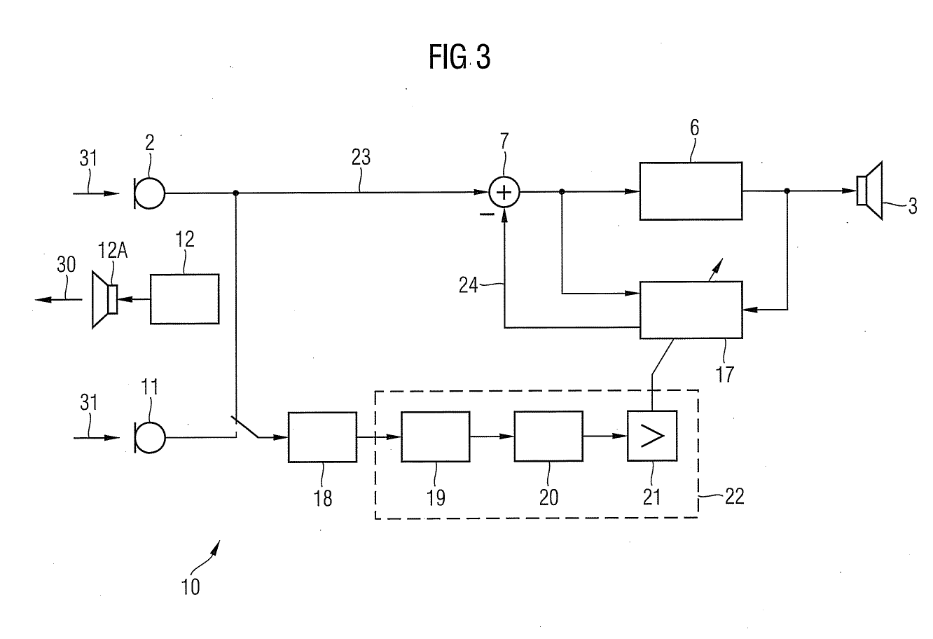

To suppress feedback the hearing aid has a feedback circuit in the signal processing unit 6. The increments of the feedback circuit are controlled by the change in the ultrasound signal received. To this end the hearing aid 10 possesses an ultrasound transmit unit 11 which sends out an ultrasound signal which is received by the microphone 2 and/or an ultrasound receive unit 12 as a result of reflections in the environment and feedback. The ultrasound signal received in this way is directed to the feedback circuit for further evaluation. The inventive functional principle is described in more detail in the block diagram shown in FIG. 3.

The hearing aid 10 in accordance with the exemplary embodiment includes as a further component a transmit and receive unit 15 with an antenna 16 for wireless exchange of data with a further hearing aid for binaural supply or with a remote control or with an audio transmit unit respectively.

FIG. 3 shows a block diagram of a hearing aid 10 with a microphone 2, a signal processing unit 6 and an earpiece 3. By means of a feedback suppression unit 17, the increment of which is able to be controlled, undesired feedback can be suppressed by the inverted fed back signal 24 determined from an electrical input signal 23 being added in the adder 7.

Regulation of the increment is decisive for optimum rapid adjustment. To this end the hearing aid 10 possesses an ultrasound transmit unit 12 with a loudspeaker 12A which sends out a modulated ultrasound signal 30. The fed back ultrasound signal 31 reflected by the environment is picked up by the microphone 2 or by a separate ultrasound receive unit 11 and directed to an ultrasound demodulator 18. The ultrasound signal 30, 31 is modulated so that it can be easily distinguished from other ultrasound signals, such as those generated by ultrasonic dog whistles to example. In the ultrasound demodulator 18 the received ultrasound signal 31 is demodulated and its power is estimated. This is fed to an input of a lowpass filter 19. The lowpass filter 19 suppresses the stochastic noise. Subsequently the lowpass-filtered signal will be fed to a differentiator 20. In this unit changes in the power of the received ultrasound signal 31 are determined. The changes are fed to a threshold value generator 21 which decides whether and how greatly the increment of the feedback suppression unit 17 will be changed. Lowpass filter 19, differentiator 20 and threshold value generator 21 together form a change detection unit 22.

The ultrasound receive unit 11 is optional and not a “must have”. Often the microphone 2 alone is sufficient to pick up the ultrasound signal 31.

The exemplary embodiment described shows a simplest realization of the invention. Other embodiments can however be significantly more complex.

### LIST OF REFERENCE SYMBOLS

1 Digital system
2 Microphone
3 Earpiece
4 Feedback path
5 adaptive filter
6 Signal processing unit
7 Adder
8 Useful signal
9 Sum signal=useful signal+feedback signal
10 In-the-ear hearing aid
11 Ultrasound transmit unit
12 Ultrasound receive unit
13 Pushbutton
14 Battery
15 Transmit/receive unit
16 Antenna
17 Feedback suppression unit
18 Ultrasound demodulator
19 Lowpass filter
20 Differentiator
21 Threshold value generator
22 Change detection unit
30 Ultrasound signal emitted
31 Ultrasound signal picked up

1.-18. (canceled)

19. A hearing device, comprising:
an ultrasound transmit unit that emits an ultrasound signal;
a microphone that receives the ultrasound signal; and
a feedback suppression unit that is regulated by the ultrasound signal for suppressing an acoustic feedback.

20. The hearing device as claimed in claim 19, further comprising a differentiation unit which detects a change in the ultrasound signal for regulating the feedback suppression unit.

21. The hearing device as claimed in claim 20, wherein an increment of the feedback suppression unit is regulates by the ultrasound signal.

22. The hearing device as claimed in claim 21, wherein the change in the ultrasound signal regulates the feedback suppression unit so that the increment is changed during the change in the ultrasound signal.

23. The hearing device as claimed in claim 21, wherein the change in the ultrasound signal regulates the feedback suppression unit so that the increment is changed during the change in the ultrasound signal and is in a predetermined manner after the change in the ultrasound signal.

24. The hearing device as claimed in claim 21, wherein a size of the change in the increment is predetermined.

25. The hearing device as claimed in claim 21, wherein a size of the change in the increment is proportional to a change of a power of the ultrasound signal.

26. The hearing device as claimed in claim 19, wherein the ultrasound signal is modulated.

27. A hearing device, comprising:
an ultrasound transmit unit that emits an ultrasound signal;
an ultrasound receive unit that receives the ultrasound signal; and
a feedback suppression unit that is regulated by the ultrasound signal for suppressing an acoustic feedback.

28. A method for suppressing an acoustic feedback in a hearing device, comprising:
emitting an ultrasound signal by an ultrasound transmit unit;
receiving the ultrasound signal by a microphone or an ultrasound receive unit;
regulating a feedback suppression unit by the ultrasound signal; and
suppressing the acoustic feedback by the feedback suppression unit.

29. The method as claimed in claim 28, wherein a change in the ultrasound signal is detected for regulating the feedback suppression unit.

30. The method as claimed in claim 29, wherein an increment of the feedback suppression unit is regulated by the ultrasound signal.

31. The method as claimed in claim 30, wherein the increment is changed during the change in the ultrasound signal.

32. The method as claimed in claim 30, wherein the increment is changed during the change in the ultrasound signal and is in a predetermined manner after the change in the ultrasound signal.

33. The method as claimed in claim 30, wherein a size of the change in the increment is predetermined.

34. The method as claimed in claim 30, wherein a size of the change in the increment is proportional to a change of a power of the ultrasound signal.

35. The method as claimed in claim 28, wherein the ultrasound signal is modulated.
